(19) United States
(12) Patent Application Publication
(10) Pub. No.: US 2024/0338406 A1
(43) Pub. Date: Oct. 10, 2024

(54) RECOMMENDATING PERSONALIZED DIGITAL DESIGN TEMPLATES UTILIZING CONTENT EMBEDDINGS

(71) Applicant: Adobe Inc., San Jose, CA (US)

(72) Inventors: Anand Khanna, San Jose, CA (US); Oliver Brdiczka, San Jose, CA (US); Nikolaos Vlassis, San Jose, CA (US)

(21) Appl. No.: 18/351,339

(22) Filed: Jul. 12, 2023

Related U.S. Application Data
(60) Provisional application No. 63/494,986, filed on Apr. 7, 2023.

(51) Int. Cl. G06F 16/56; G06F 16/583

(52) U.S. Cl. CPC G06F 16/56; G06F 16/583

(57) ABSTRACT

The present disclosure relates to systems, methods, and non-transitory computer-readable media that utilizes embedding vectors to identify a subset of digital design templates to recommend to a client device based on individual user events. For instance, the disclosed systems extract metadata from digital design templates and generate, utilizing a transformer, a plurality of embedding vectors for the digital design templates from the extracted metadata. Further, the disclosed system generates, utilizing the transformer, a user embedding vector from one or more user events of a user. Moreover, the disclosed system utilizes identifies, utilizing a similarity search model, a subset of digital design templates from the digital design templates to recommend to the user by identifying one or more embedding vectors of the plurality of embedding vectors that satisfy a similarity threshold to the user embedding vector.

### CROSS REFERENCE TO RELATED APPLICATIONS

This application claims the benefit of and priority to U.S. Provisional Patent Application No. 63/494,986, filed Apr. 7, 2023, entitled PERSONALIZED DIGITAL DESIGN TEMPLATE RECOMMENDATIONS UTILIZING TEMPLATE CONTENT EMBEDDINGS, which is incorporated herein by reference in its entirety.

### BACKGROUND

Recent years have seen significant advancement in hardware and software platforms for enabling client devices to create and/or manipulate digital content. For example, many platforms offer software applications that provide pre-created designs/templates for users to modify. Some of these platforms further implement systems for recommending, to a client device, particular digital designs.

### SUMMARY

One or more embodiments described herein provide benefits and/or solve one or more of problems in the art with systems, methods, and non-transitory computer-readable media that generate personalized digital design template recommendations based on individual user activity with digital design templates utilizing embedding vectors generated utilizing a transformer. For instance, in one or more embodiments, the disclosed system extracts metadata (e.g., title, text description, category, topics, tasks, etc. for a specific template) from digital design templates included within a dataset. Further, by utilizing a sentence transformer, the disclosed system generates embedding vectors from the extracted metadata which enables the disclosed system to contextually understand the digital design templates within the dataset. Moreover, based on individual user activity/events, in some embodiments the disclosed system identifies a subset of digital design templates to recommend to an individual user. For instance, in some embodiments, the disclosed system detects aggregated individual user events such as digital design template exports, search queries, and modifications to digital design templates (e.g., remixes). Additionally, in one or more embodiments, the disclosed system generates a user embedding vector from the aggregated individual user events utilizing the sentence transformer. Further, in some embodiments, utilizing a similarity search model, the disclosed system identifies a subset of digital design templates by comparing the user embedding vectors with the embedding vectors for the digital design templates. In doing so, the comparison identifies and recommends relevant digital design templates to a user.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a personalized digital design template recommendation system operates in accordance with one or more embodiments;

FIG. 2 illustrates an overview diagram of the personalized digital design template recommendation system identifying a subset of digital design templates to recommend to an individual user via a client device in accordance with one or more embodiments;

FIG. 3 illustrates a diagram of the personalized digital design template recommendation system generating a plurality of embedding vectors for a plurality of digital design templates and user embedding vectors based on individual user events in accordance with one or more embodiments;

FIG. 4A illustrates a diagram of the personalized digital design template recommendation system extracting metadata from a digital design template in accordance with one or more embodiments;

FIG. 4B illustrates a diagram of the personalized digital design template recommendation system generating embedding vectors and compacting the size of the embedding vectors in accordance with one or more embodiments;

FIG. 5A illustrates an example graph of the personalized digital design template recommendation system using a dimension reduction model in accordance with one or more embodiments;

FIGS. 5B-5C illustrates a diagram for the personalized digital design template recommendation system selecting a random digital design template after applying the dimension reduction model and subsequently identifying similar digital design templates in accordance with one or more embodiments;

FIG. 6 illustrates a diagram of the personalized digital design template recommendation system detecting individual user events in accordance with one or more embodiments;

FIGS. 7A-7B illustrates diagrams of the personalized digital design template recommendation system detecting individual user events and modifying recommendations for digital design templates based on additional individual user events in accordance with one or more embodiments;

FIG. 8 illustrates a diagram of the personalized digital design template recommendation system implemented with an email application server to provide digital design template recommendations in accordance with one or more embodiments;

FIG. 9 illustrates an example graphical user interface providing various recommendations provided by an email application server in accordance with one or more embodiments;

FIG. 10 illustrates a diagram of the personalized digital design template recommendation system providing multiple rows of digital design template recommendations in accordance with one or more embodiments;

FIG. 11 illustrates a diagram of the personalized digital design template recommendation system providing personalized template recommendations within a browser graphical user interface in accordance with one or more embodiments;

FIG. 12 illustrates an example schematic diagram of the personalized digital design template recommendation system in accordance with one or more embodiments;

FIG. 13 illustrates a flowchart of a series of acts for identifying and providing to a user digital design templates as recommendations in accordance with one or more embodiments; and

FIG. 14 illustrates a block diagram of an exemplary computing device in accordance with one or more embodiments.

### DETAILED DESCRIPTION

One or more embodiments described herein include a personalized digital design template recommendation system that generates personalized digital design template recommendations based on individual user activity utilizing embedding vectors generated via a transformer. The personalized digital design template recommendation system provides several advantages over conventional systems. For example, conventional systems suffer from several technological shortcomings that result in inefficient and inflexible operation. Conventional recommendation systems often fail to operate efficiently. For example, because conventional systems tend to provide static recommendations that are irrelevant to a user of the client device, such systems typically require a significant amount of user interactions with the client device to access those application features that are relevant. Often, conventional systems upon “cold-start” provide generic global based recommendations. As such, users of conventional systems are required to scroll or navigate through numerous templates before finding one that matches their creative purposes. In particular, efficiency concerns on mobile devices for these conventional recommendation systems are exacerbated, due to the smaller screen size and hundreds of thousands of templates typically available.

In addition to the efficiency concerns mentioned above, conventional systems also suffer from inflexibility concerns. While conventional systems make recommendations, these recommendations typically do not recommend content that represents the actual creative intent and creative segment of an individual user in the realm of creative purposes such as digital design templates. For example, due to creative designers having a wide range of dynamic purposes/interests, conventional systems that manage to provide recommendations based on global patterns still fall short of providing relevant/meaningful recommendations. Thus, because conventional recommendation systems fail to recommend content that is representative of an individual creative intent of a user, the individual user often receives irrelevant and out-of-date content. Accordingly, conventional systems are inflexible in updating and matching the creative purposes of users working with digital design templates.

In one or more embodiments, the personalized digital design template recommendation system operates more efficiently than conventional systems. For example, the personalized digital design template recommendation system generates, utilizing a sentence transformer, a plurality of embedding vectors for a plurality of digital design templates within a dataset. Further, in some embodiments, the personalized digital design template recommendation system detects individual user events (e.g., exports, modifications, search queries, etc.) and generates a user embedding vector for the individual user events (e.g., a combined user signal for the individual user events). In some embodiments, the personalized digital design template recommendation system projects the embedding vectors of the digital design templates in a single latent space for efficient comparison with the user embedding vector. Specifically, in some instances the personalized digital design template recommendation system utilizes a similarity search model to generate in real-time, digital design template recommendations for a user. For instance, the personalized digital design template recommendation system identifies digital design templates closest in similarity to the user embedding vector of the individual user events. Indeed, because of this, in many instances, the personalized digital design template recommendation system eliminates interactive steps needed to navigate through numerous menus, sub-menus, and/or windows to access a desired digital design template. Moreover, individualized geo-seasonal intent data (e.g., a spouse's anniversary or a family member's birthday) utilized by the personalized digital design template recommendation system results in lower production constraints (e.g., the availability and scalability of software that implements the personalized digital design template recommendation system) and the filtering of digital design templates based on an embedding vectors-based approach to provide more relevant and efficient data to individual users.

In addition, in one or more embodiments, the personalized digital design template recommendation system operates with improved flexibility as compared to conventional systems. In particular, by dynamically updating the recommendations that are presented in real time based on individual user events (e.g., exports, remixes/modifications, search queries), the personalized digital design template recommendation flexibly improves upon the static recommendations provided under conventional systems. Moreover, in some embodiments the personalized digital design template recommendation system enables real-time personalized digital design template recommendations, personally tailored to an individual user based on their activity. The personalized digital design template recommendation system does so by generating a plurality of embedding vectors to represent a plurality of digital design templates (e.g., all the digital design templates within a dataset), and further generating a user embedding vector to represent the aggregation of individual user events.

As mentioned above, the personalized digital design template recommendation system provides tailored personalized recommendations for digital design templates. In one or more embodiments, the personalized digital design template recommendation system interacts with multiple application surfaces. In particular, in some embodiments the personalized digital design template recommendation system interacts with web application, mobile applications, email campaign applications, and partner websites. For instance, the personalized digital design template recommendation system provides/surfaces personalized digital design template recommendations in a unified manner across multiple application surfaces and in real-time. Further, in one or more embodiments, the personalized digital design template recommendation system implemented within various applications provides a scalable system that dynamically adapts by recommending digital design templates based on the content within the digital design templates. For instance, for an individual user, personal projects such as “birthday card” or “new year resolution” digital design templates, the individual user can further benefit from receiving similar templates as recommendations. In particular, in one or more embodiments, if the individual user has had a recent interaction with such templates, the personalized digital design template recommendation system recommends similar templates. On the other hand, in some embodiments, if the personalized digital design template recommendation system determines individualized geo-seasonal intent, the personalized digital design template recommendation system can recommend the “birthday card” or “new year resolution” digital design templates the following year. Accordingly, for a recommendation feed, the personalized digital design template recommendation system captures user signals (e.g., individual user events) for recent events as well as annual seasonal interactions to provide relevant and accurate recommendations to an individual user.

As mentioned, in one or more embodiments, the personalized digital design template recommendation system understands content of various digital design templates. For example, the personalized digital design template recommendation system understands content of digital design templates by generating embedding vectors for each digital design template using template metadata. In particular, in some embodiments the template metadata includes title, text, description, categories, topics, and tasks. Further, in some embodiments the template metadata provides context for certain stylistic elements of each template which the personalized digital design template recommendation system further utilizes to surface personalized recommendations with similar styles. Unlike, prior systems, in one or more embodiments, the personalized digital design template recommendation system does not rely on hand-labeled, or metadata tagged by designers. As such, in some embodiments the personalized digital design template recommendation system accurately identifies individual user events and corresponding digital design templates to similarly match the individual user events.

As just mentioned, in one or more embodiments the personalized digital design template recommendation system identifies individual user evens. For example, the personalized digital design template recommendation system captures in real-time via an individual user event stream aggregation layer, individual user events. In particular, in some embodiments the personalized digital design template recommendation system captures individual user events such as template remixes (e.g., beginning to edit a digital design template), template exports, and search queries.

Furthermore, in one or more embodiments the personalized digital design template recommendation system utilizes an exponential decay function for weighting the individual user events. For example, the personalized digital design template recommendation system ranks using a weight assigned to each individual user event based on recency and importance in an individual user's activity (e.g., geo-seasonal intent). In particular, in some embodiments the personalized digital design template recommendation system utilizes the exponential decay function to account for recent interaction history as well as interactions from a year prior and assigns higher weights to such interactions. Moreover, in some embodiments based on the assigned weight, the personalized digital design template recommendation system provides a specific number of digital design template recommendations.

Moreover, in one or more embodiments the personalized digital design template recommendation system scales to support a vast number of digital design templates. For example, the personalized digital design template recommendation system utilizes a similarity search model to perform fast pairwise distance computations across a digital design template latent space (e.g., the latent vectors or embedding vectors of the plurality of digital design templates). In particular, in some embodiments the personalized digital design template recommendation system performs real-time recommendations by comparing a user embedding vector (e.g., of the individual user events) with embedding vectors of the plurality of digital design templates within the same latent space. In doing so, the personalized digital design template recommendation system identifies a subset of digital design templates to recommend to an individual user.

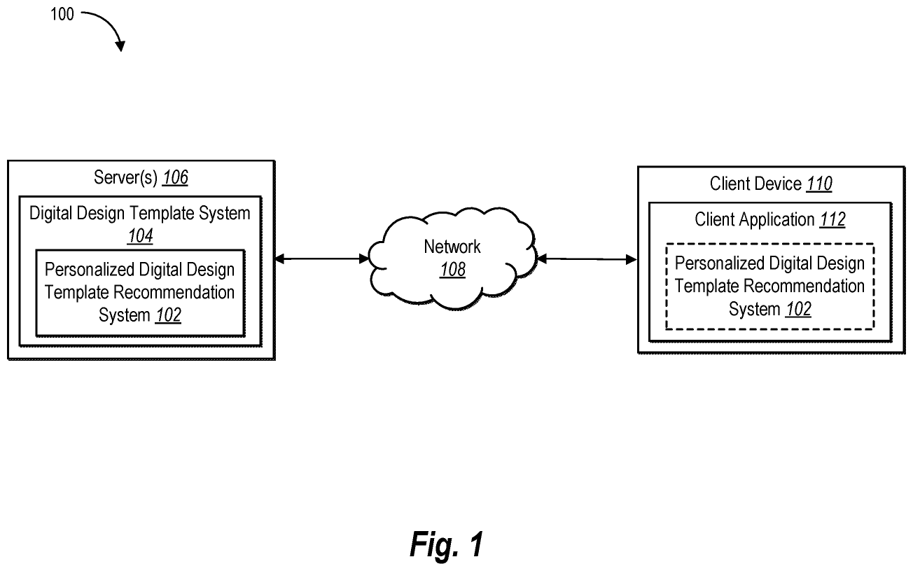

Additional detail regarding the personalized digital design template recommendation system will now be provided with reference to the figures. For example, FIG. 1 illustrates a schematic diagram of an exemplary system 100 in which a personalized digital design template recommendation system 102 operates. As illustrated in FIG. 1, the system 100 includes a server(s) 106, a network 108, and client device 110. Although the system 100 of FIG. 1 is depicted as having a particular number of components, the system 100 is capable of having any number of additional or alternative components (e.g., any number of servers, client devices, or other components in communication with the personalized digital design template recommendation system 102 via the network 108). Similarly, although FIG. 1 illustrates a particular arrangement of the server(s) 106, the network 108, and the client device 110, various additional arrangements are possible.

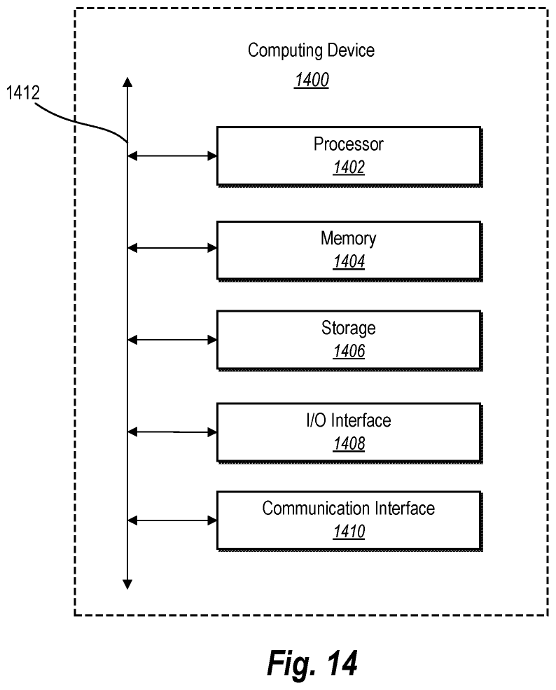

The server(s) 106, the network 108, and the client device 110 are communicatively coupled with each other either directly or indirectly (e.g., through the network 108 discussed in greater detail below in relation to FIG. 14). Moreover, the server(s) 106 and the client device 110 include one or more of a variety of computing devices (including one or more computing devices as discussed in greater detail with relation to FIG. 14).

As mentioned above, the system 100 includes the server(s) 106. In one or more embodiments, the server(s) 106 generates, stores, receives, and/or transmits data including models, digital content, and recommendations for design templates. In one or more embodiments, the server(s) 106 comprises a data server. In some implementations, the server(s) 106 comprises a communication server or a web-hosting server. Further, the server(s) 106 include a digital design template system 104 which further includes the personalized digital design template recommendation system 102.

In one or more embodiments, the client device 110 includes computing devices that access, edit, segment, modify, store, and/or provide, for display, digital content such as digital design templates. For example, the client device 110 include smartphones, tablets, desktop computers, laptop computers, head-mounted-display devices, or other electronic devices. The client device 110 includes one or more applications (e.g., the client application 112) that access, edit, segment, modify, store, and/or provide, for display, digital content such as digital design templates. For example, in one or more embodiments, the client application 112 includes a software application installed on the client device 110. Additionally, or alternatively, the client application 112 includes a software application hosted on the server(s) 106 which are accessible by the client device 110 through another application, such as a web browser.

To provide an example implementation, in some embodiments, the personalized digital design template recommendation system 102 on the server(s) 106 supports the personalized digital design template recommendation system 102 on the client device 110. For instance, in some cases, the personalized digital design template recommendation system 102 on the server(s) 106 gathers data. The personalized digital design template recommendation system 102 then, via the server(s) 106, provides the data to the client device 110. In other words, the client device 110 obtains (e.g., downloads) the personalized digital design template recommendation system 102 from the server(s) 106. Once downloaded, the personalized digital design template recommendation system 102 on the client device 110 generates personalized recommendations for digital design templates.

In alternative implementations, the personalized digital design template recommendation system 102 includes a web hosting application that allows the client device 110 to interact with content and services hosted on the server(s) 106. To illustrate, in one or more implementations, the client device 110 accesses a software application supported by the server(s) 106. In response, the personalized digital design template recommendation system 102 on the server(s) 106 generates and provides one or more recommendations. The server(s) 106 provides the recommendations to the client device 110 for display.

To illustrate, in some cases, the personalized digital design template recommendation system 102 on the client device 110 collects and aggregates one or more individual user signals reflecting a behavior with respect to a software application supported by the server(s) 106. The client device 110 transmits the aggregation (e.g., a de-duplicated timestamp history of events) to the server(s) 106. In response, the personalized digital design template recommendation system 102 on the server(s) 106 further aggregates the individual user signals and generates and provides one or more recommendations for application features.

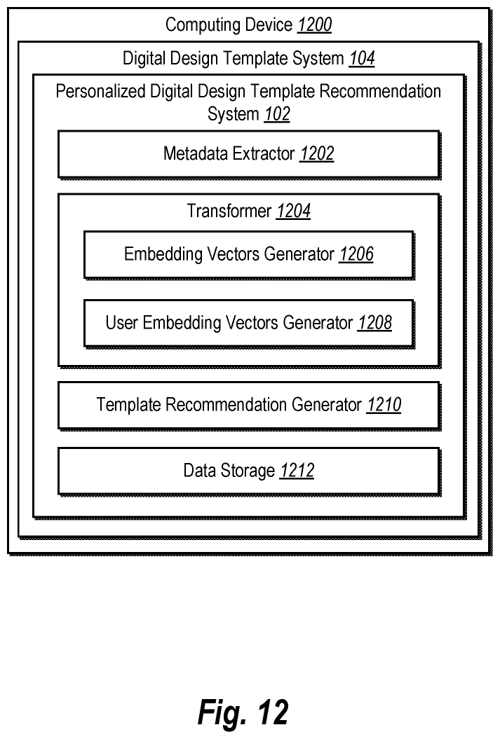

Indeed, the personalized digital design template recommendation system 102 is able to be implemented in whole, or in part, by the individual elements of the system 100. Indeed, although FIG. 1 illustrates the personalized digital design template recommendation system 102 implemented with regard to the server(s) 106, different components of the personalized digital design template recommendation system 102 are able to be implemented by a variety of devices within the system 100. For example, one or more (or all) components of the personalized digital design template recommendation system 102 are implemented by a different computing device (e.g., the client device 110) or a separate server from the server(s) 106. Indeed, as shown in FIG. 1, the client device 110 includes the personalized digital design template recommendation system 102. Example components of the personalized digital design template recommendation system 102 will be described below with regard to FIG. 12.

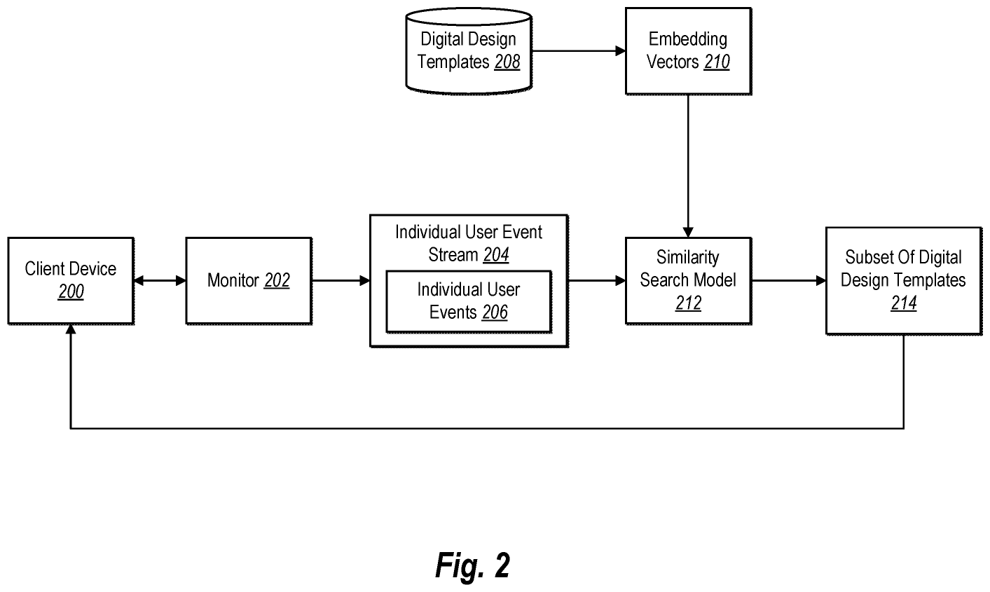

As mentioned, in one or more embodiments, the personalized digital design template recommendation system 102 identifies a subset of digital design templates. For example, FIG. 2 illustrates the personalized digital design template recommendation system 102 performing an act 202 of monitoring a client device 200. In particular, the personalized digital design template recommendation system 102 monitors behavior with respect to the software application by monitoring user interactions of the client device 200 (e.g., of a user of the client device 200) with a graphical user interface of the client device 200. For instance, in some cases, the personalized digital design template recommendation system 102 monitors a user selection of a digital design template. Further, in some embodiments, the personalized digital design template recommendation system 102 monitors a user exporting a digital design template or performing a search query. Further, in some embodiments, the personalized digital design template recommendation system 102 monitors a user failing to select a digital design template when the personalized digital design template recommendation system 102 causes a client device to present the digital design template via a graphical user interface.

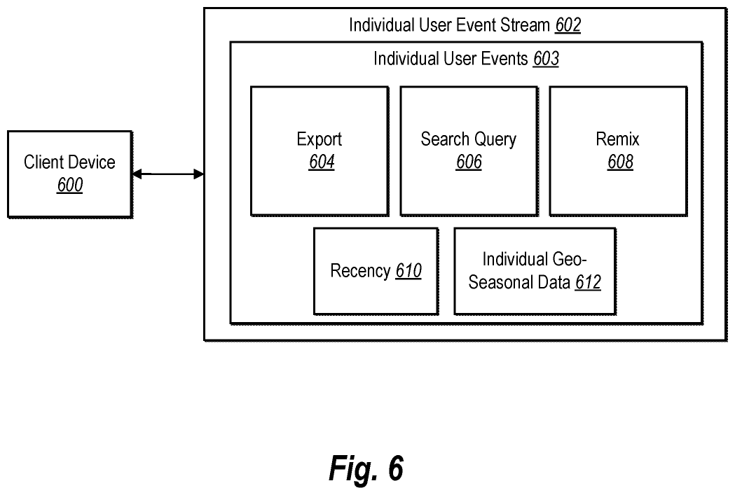

As shown in FIG. 2, based on the personalized digital design template recommendation system 102 monitoring the client device 200, the personalized digital design template recommendation system 102 determines individual user events 206 for a specific user. For example, the personalized digital design template recommendation system 102 processes the monitored behavior at an individual user event stream 204 to determine various indicators of the individual user events 206. In particular, as mentioned above, the personalized digital design template recommendation system 102 monitors user behavior, such as individual user events which includes i) exports ii) remixes and iii) search queries. Additional details regarding individual user events 206 is given below in the description of FIG. 6.

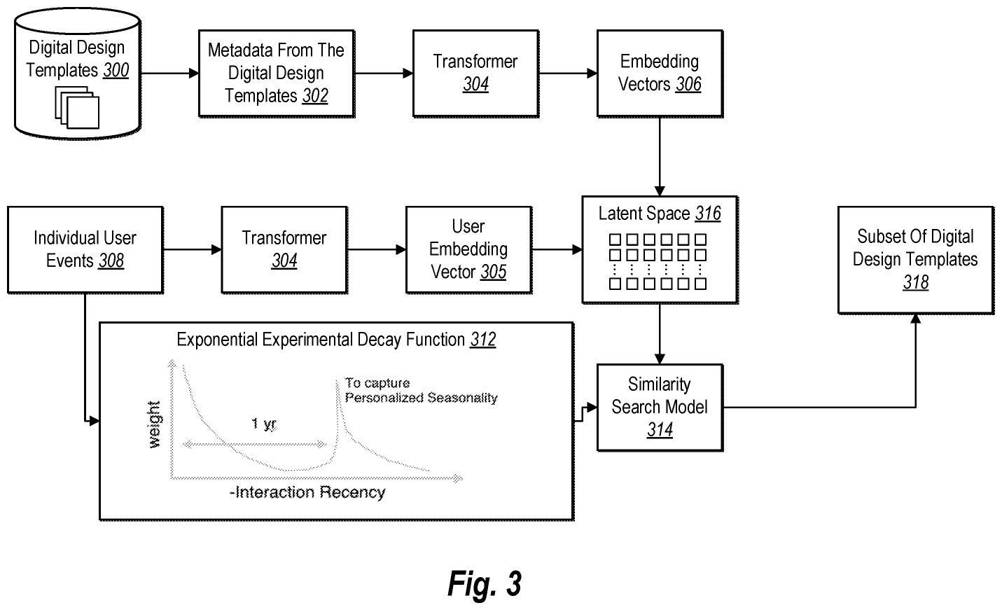

Moreover, the personalized digital design template recommendation system 102 passes the individual user events 206 from the individual user event stream 204 to a similarity search model 212. For example, the personalized digital design template recommendation system 102 generates a user embedding vector from the individual user events 206 and the similarity search model compares the user embedding vector with embedding vectors 210 within a latent space. Additional details regarding generating embedding vectors from the individual user events 206 and the similarity search model 212 are given below in FIG. 3.

Furthermore, FIG. 2 shows the personalized digital design template recommendation system 102 generating the embedding vectors 210 (e.g., a plurality of embedding vectors) from digital design templates 208. The personalized digital design template recommendation system 102 further passes the embedding vectors 210 from the digital design templates 208 to the similarity search model 212. Moreover, in one or more embodiments, the personalized digital design template recommendation system 102 stores the embedding vectors 210 in a database corresponding with the digital design templates 208. In some embodiments, the personalized digital design template recommendation system 102 stores the embedding vectors 210 in the same database as the digital design templates 208, while in other embodiments the personalized digital design template recommendation system 102 stores the embedding vectors 210 in a separate database. Additional details regarding generating the embedding vectors 210 is given below in the description of FIG. 3.

As shown in FIG. 2, the personalized digital design template recommendation system 102 utilizes the similarity search model 212 to process the embedding vectors 210 and the user embedding vector of the individual user events 206. In particular, the personalized digital design template recommendation system 102 utilizes the similarity search model 212 to find the closest set of matches of digital design templates to recommend to an individual user based on their individual user events 206 (e.g., based on the user embedding vector). For instance, as shown, the personalized digital design template recommendation system 102 identifies a subset of digital design templates 214 and provides the subset to the client device 200.

FIG. 3 shows the personalized digital design template recommendation system 102 processing digital design templates 300. For example, the digital design templates 300 include an existing digital design with one or more design features and/or digital design elements. For example, in one or more embodiments, the digital design templates include an overlay and an underlying image. In particular, the digital design templates 300 cover a wide variety of themes, events, and occasions. For instance, the digital design templates 300 include holidays, events for specific tasks (e.g., business, marketing, social media, etc.), and themes (nature, traveling, countries, cultures, traditions, etc.). Specifically, the personalized digital design template recommendation system 102 provides digital design templates 300 to a user of an editing application to make modifications to an existing digital design template. In at least one embodiment, the personalized digital design template recommendation system 102 includes a database that stores a library of digital design templates. For instance, the library can contain thousands to millions of digital design templates.

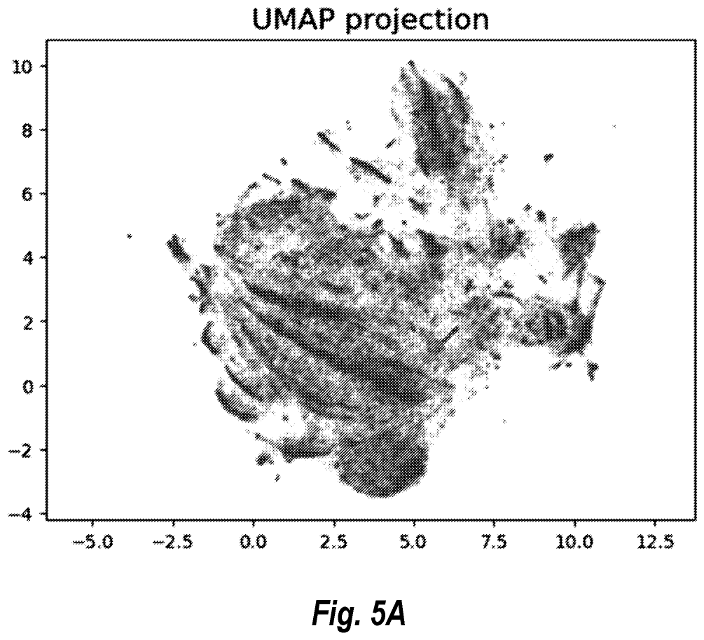

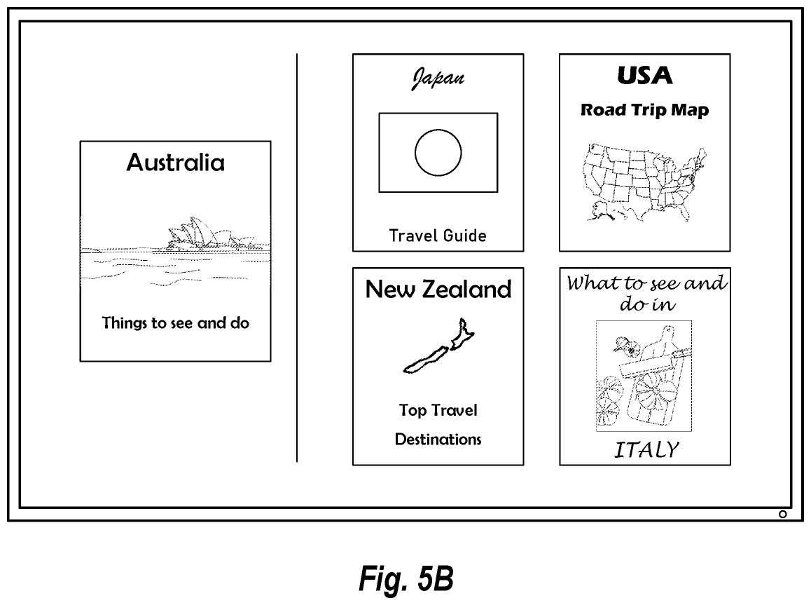

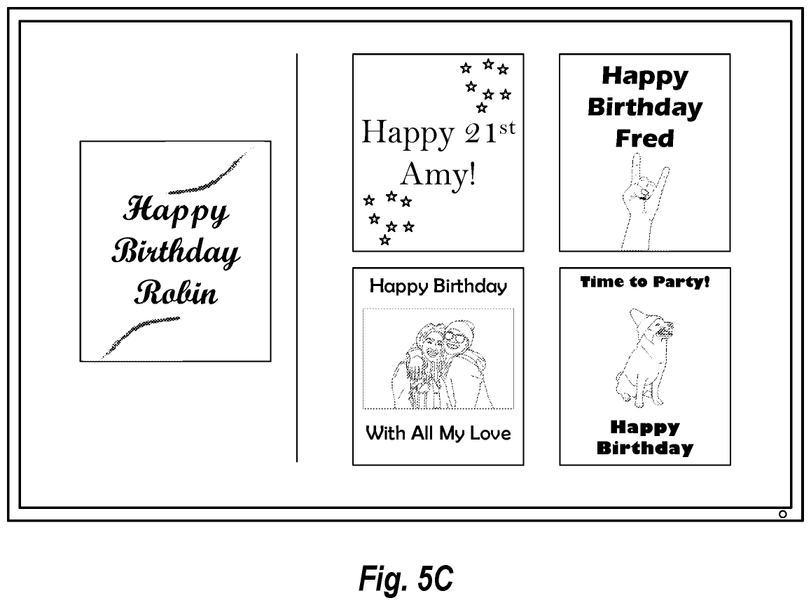

As further shown in FIG. 3, the personalized digital design template recommendation system 102 extracts metadata 302. For example, the personalized digital design template recommendation system 102 extracts the metadata 302 from the digital design templates 300. In particular, the personalized digital design template recommendation system 102 extracts the metadata 302 from each digital design template of the digital design templates 300. For instance, the personalized digital design template recommendation system 102 identifies a template identifier for each digital design template and extracts its associated metadata 302. Specifically, the personalized digital design template recommendation system 102 extracts the metadata 302 such as title, text, description, categories, topics, and tasks. A concrete example of the personalized digital design template recommendation system 102 extracting metadata 302 is given below in the description of FIG. 5A.

Moreover, the personalized digital design template recommendation system 102 utilizes a machine learning model to process the metadata 302. In one or more embodiments, a machine learning model refers to a computer representation that that is tunable (e.g., trained) based on inputs to approximate unknown functions. In particular, in some embodiments, a machine learning model refers to a model that utilizes algorithms to learn from, and make predictions on, known data by analyzing the known data to learn to generate outputs that reflect patterns and attributes of the known data. For instance, in some instances, a machine learning model includes, but is not limited to a neural network (e.g., a convolutional neural network, recurrent neural network, transformer, or other deep learning network), a decision tree (e.g., a gradient boosted decision tree), association rule learning, inductive logic programming, support vector learning,

Bayesian network, regression-based model (e.g., censored regression), principal component analysis, or a combination thereof. In one or more implementation, the machine learning model is transformer 304 that includes a neural network architecture. For example, the transformer 304 utilizes a self-attention mechanisms that allows the model to weight the significance of different portions of input data. In particular, the transformer 304 utilizes the self-attention mechanism to attend to different parts of the input sequence simultaneously. For instance, the transformer 304 splits an input sequence into fixed-length segments mapped to a high-dimensional vector representation and feeds the vectors into a series of multi-headed attention and feedforward layers. Specifically, the personalized digital design template recommendation system 102 utilizes a sentence transformer as the transformer 304. To illustrate, the personalized digital design template recommendation system 102 trains the sentence transformer on Siamese BERT-network architecture to enable a high level of understanding semantics within a sentence or a document.

As shown, by processing the metadata 302 with the transformer 304, the personalized digital design template recommendation system 102 generates embedding vectors 306 (e.g., a plurality of embedding vectors). For example, the embedding vectors 306 includes a numerical representation of the metadata 302 in a high-dimensional space. In particular, the embedding vectors 306 includes a vector of real numbers mapped to a point within a high-dimensional space. Furthermore, the embedding vectors 306 captures the semantic meaning and relationships between entities which allows various models to better understand and process the embedding vector 306 for downstream tasks. Note that FIG. 3 shows the personalized digital design template recommendation system 102 generating the embedding vectors 306 because the personalized digital design template recommendation system 102 generates an embedding vector for each digital design template of the digital design templates 300.

Moreover, as shown, the personalized digital design template recommendation system 102 also processes individual user events 308. As discussed previously, the individual user events 308 can include template interactions (e.g., remixes and exports), template metadata (e.g., indicative of stylistic qualities of a digital design template and/or geo-seasonal intent), and user search queries.

Specifically, the personalized digital design template recommendation system 102 processes the individual user events 308 with the transformer 304. For instance, the transformer 304 enables the personalized digital design template recommendation system 102 to generate a user embedding vector 305 of the user events. Further, the personalized digital design template recommendation system 102 projects the user embedding vector 305 (e.g., from aggregating the individual user events 308 into a combined user signal) into a single latent space 316 for further comparison against the embedding vectors 306 of the digital design templates 300. In particular, by utilizing the transformer 304 to process the individual user events 308, the personalized digital design template recommendation system 102 generates a combined user signal of the individual user events 308 via generating the user embedding vector 305 to project into the single latent space 316. Moreover, the personalized digital design template recommendation system 102 constantly processes updated individual user events based on additional user activity to generate an additional user embedding vector.

As shown, the personalized digital design template recommendation system 102 further utilizes an exponential decay function 312. For example, the exponential decay function 312 assigns weights to various individual user events 308. In particular, the personalized digital design template recommendation system 102 utilizes the exponential decay function 312 to assign weights depending on the recency of the individual user events 308 and the individualized geo-seasonal intent (e.g., spouse's anniversary or the individual's birthday). For instance, the personalized digital design template recommendation system 102 incorporates recent interaction history and seasonal interactions (e.g., a year in the past) and assigns higher weights to such interactions. For seasonal interactions, the personalized digital design template recommendation system 102 assigns a weight corresponding to the seasonal importance. To illustrate, the personalized digital design template recommendation system 102 utilizes the exponential decay function 312 to assign a higher weight to interactions such as birthday, Christmas, or Diwali, but does not assign a higher weight for digital design templates such as business card or menu.

Furthermore, the personalized digital design template recommendation system 102 utilizes the exponential decay function 312 due to an individual user's constantly changing activity. For example, an individual user may work on multiple creative projects. In particular, an individual user who works as a small business owner may create different menus for their restaurant, but the individual user may also need to create a birthday party invite. Accordingly, the personalized digital design template recommendation system 102 tracks the individual user's most recent interactions to understand the individual user's relevant interests.

For instance, the personalized digital design template recommendation system 102 utilizes the exponential decay function to assign higher weights to the most recent interactions. Specifically, this could include the six most recent searches of an individual user. Moreover, the personalized digital design template recommendation system 102 utilizes the assigned weights to the individual user events 308, to determine a number of similar templates to provide as recommendations. For example, a geo-seasonal birthday template for an individual user may receive a high weight and as a result, the personalized digital design template recommendation system 102 provides more template recommendations related to the birthday than for a search query performed twenty searches ago.

In one or more embodiments, the personalized digital design template recommendation system 102 utilizes the following exponential decay function:

$$exp ( - \frac{i}{\frac{decay half life}{log ( 2 )}} )$$

In particular, the personalized digital design template recommendation system 102 utilizes the above exponential decay function to identify relevant digital design templates to recommend to a user. Global trends can typically show huge spikes in exports and remixes of “Christmas” and “New Year” templates towards the end of the year in the United States region. However, the personalized digital design template recommendation system 102 utilizing the exponential decay function can further hone in on nuanced, personalized, and tailored digital design template recommendations. Specifically, the personalized digital design template recommendation system 102 provides tailored recommendations at a granular level that looks to the individual user events 308. Furthermore, the exponential decay function 312 includes two high weight peaks that decay exponentially. The first peak includes the most recent events while the second peak occurs for interactions that occurred around one year in the past to capture any interactions that may have been seasonal in nature (e.g., individual geo-seasonal intent data).

As just mentioned, the personalized digital design template recommendation system 102 personalizes seasonality. In particular, the personalized digital design template recommendation system 102 an individual annual pattern of behavior based on interactions with design templates. For example, an advantage of personalizing seasonality at a granular level provides for an individual user logging in from any part of the world to still receive seasonal recommendations based on their own history. In particular, the personalized digital design template recommendation system 102 identifies Diwali as a recommended digital design template for an individual user who created a Diwali template during October while being in a geographic location where Diwali is not popular. Further, merely relying on generalized geo-seasonal feeds fails to capture seasonal events personal to the user such as, birthdays and anniversaries. However, the personalized digital design template recommendation system 102 utilizing the exponential decay function 312 provides an advantage of capturing personalized seasonality. Moreover, the personalized digital design template recommendation system 102 utilizing the exponential decay function 312 further ranks the individual user events 308 utilizing a variety of methods.

For instance, the personalized digital design template recommendation system 102 ranks based on the recency of an interaction between an individual user and an item (e.g., a digital design template). In particular, the personalized digital design template recommendation system 102 ranks more recent interactions with digital design templates with a high weight of importance in calculating an overall relevance score for a digital design template. In other words, the personalized digital design template recommendation system 102 utilizes interleaved based interaction recency when implementing the exponential decay function 312 to weigh individual user events.

Furthermore, in one or more embodiments, the personalized digital design template recommendation system 102 also utilizes the exponential decay function 312 with product of weight and similarity distance to weigh various individual user events. For instance, product of weight and similarity distance includes determining a similarity between embedding vectors of digital design templates and the user embedding vector 305. For product of weight and similarity distance, the personalized digital design template considers both the similarity and the importance of each attribute or feature in determining the similarity. To illustrate, in comparing the user embedding vector 305 with various embedding vectors of digital design templates with similar attributes, the personalized digital design template recommendation system 102 can weigh one attribute as more important (e.g., template exports) than another attribute (e.g., a query search) in determining similarity. This results in giving more weight to an emphasized attribute in calculating an overall similarity score between digital design templates. The modularity of this approach allows for a lot of experimentation scope with the ranking function and the variables of the decay function, such as the decay rate.

As shown, the personalized digital design template recommendation system 102 further utilizes a similarity search model 314. For example, the similarity search model efficiently searches embedding vectors to find an embedding vector most similar to an input (e.g., the user embedding vector 305). In particular, the similarity search model 314 compares embedding vectors of the individual user events 308 with the embedding vectors 306 of the digital design templates 300. In doing so, the personalized digital design template recommendation system 102 identifies a subset of digital design templates 318. Furthermore, as shown, the similarity search model 314 also receives inputs from the exponential decay function 312. The inputs from the exponential decay function 312 further allow the personalized digital design template recommendation system 102 to identify a number of similar digital design templates corresponding to the inputs from the exponential decay function 312 (e.g., the exponential decay function 312 weighs the individual user events 308).

Moreover, in one or more embodiments, the personalized digital design template recommendation system 102 in identifying the subset of digital design templates 318 applies additional filtering criteria. In particular, the personalized digital design template recommendation system 102 applies additional filtering criteria such as template design filters (e.g., Instagram post, Facebook cover, YouTube thumbnails), user segment filters (e.g., small business, personal project), aspect ratio filters (e.g., squares, portraits, horizontal), or template style filters (e.g., bold, contemporary).

In some embodiments, the personalized digital design template recommendation system 102 utilizes a cosine similarity search to identify similar digital design templates. In one or more embodiments, the personalized digital design template recommendation system 102 implements the similarity search model 314 for efficiently searching across millions to billions of high dimensional vectors. To further increase computing efficiency, the personalized digital design template recommendation system 102 implements a threshold for removing digital design templates 300 (e.g., the embedding vectors of digital design templates) from a similarity search. In particular, the personalized digital design template recommendation system 102 removes digital design templates that fails to satisfy a threshold relating to date of creation or date of updates applied to a digital design template. To illustrate, the personalized digital design template recommendation system 102 implements a threshold of six months for either creating a digital design template or updating a digital design template. Specifically, this threshold filter promotes newer and fresher digital design templates.

In one or more embodiments the personalized digital design template recommendation system 102 utilizes an artificial intelligence similarity search as the similarity search model. In particular, the personalized digital design template recommendation system 102 implements the artificial intelligence similarity search to provide support for multiple high speed pairwise distance calculations to generate a digital design template feed in real time. For instance, the personalized digital design template recommendation system 102 utilizes the artificial intelligence similarity search for robust vectorized searches supported through both CPU and GPU to compute multiple pairwise distance operations extremely quickly. The personalized digital design template recommendation system 102 implementing the artificial intelligence similarity search enables the personalized digital design template recommendation system 102 to efficiently work across a latent space of a billion high dimensional vectors. To illustrate, in one or more embodiments, the personalized digital design template recommendation system 102 implements the artificial intelligence similarity search as described by Jegou et al. in Faiss: A library for efficient similarity search, Mar. 29, 2017 (Faiss: A library for efficient similarity search-Engineering at Meta (fb.com)), the entire contents of which are hereby incorporated by reference in their entirety. In alternative implementations, the personalized digital design template recommendation system 102 implements the artificial intelligence similarity search as described by Gupta et al. in Bliss: A Billion scale Index using Re-partitioning, KDD '22: Proceedings of the 28th ACM SIGKDD Conference on Knowledge Discovery and Data Mining, August 2022, Pages 486-495, the entire contents of which are hereby incorporated by reference in their entirety.

Specifically, the personalized digital design template recommendation system 102 processes the embedding vectors 306 and puts them into an index. The personalized digital design template recommendation system 102 performs a similarity search for the user embedding vector 305 for a user x in dimension d and performs the operation: i=argminᵢ|x−xᵢ∥, wherein ∥⋅∥ is the Euclidean distance L2. Specifically, the personalized digital design template recommendation system 102 determines via the FAISS the argmin, which is a search operation on the aforementioned index. The personalized digital design template recommendation system 102 via the FAISS returns not just the nearest neighbor, but also the 2nd nearest, 3rd, . . . , and the k-th nearest neighbor. The personalized digital design template recommendation system 102 searches several vectors at a time rather than one by utilizing batch processing. For many index types, searching several vectors at a time is faster than searching one vector after another. In one or more embodiments, the personalized digital design template recommendation system 102 trades precision for speed, i.e., gives an incorrect result 10% of the time with a method that is 10× faster and/or uses 10× less memory. Accordingly, the personalized digital design template recommendation system 102 performs the maximum inner product search argmax instead of a minimum Euclidean search. Thus, the personalized digital design template recommendation system 102 can search across billions of embedding vectors 306 within seconds to identify a digital design template(s) closest to the user embedding vector 305.

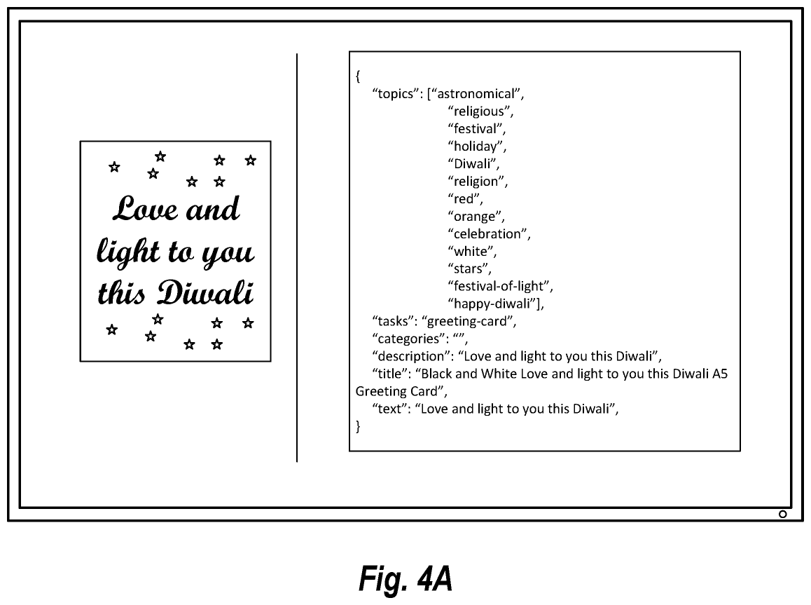

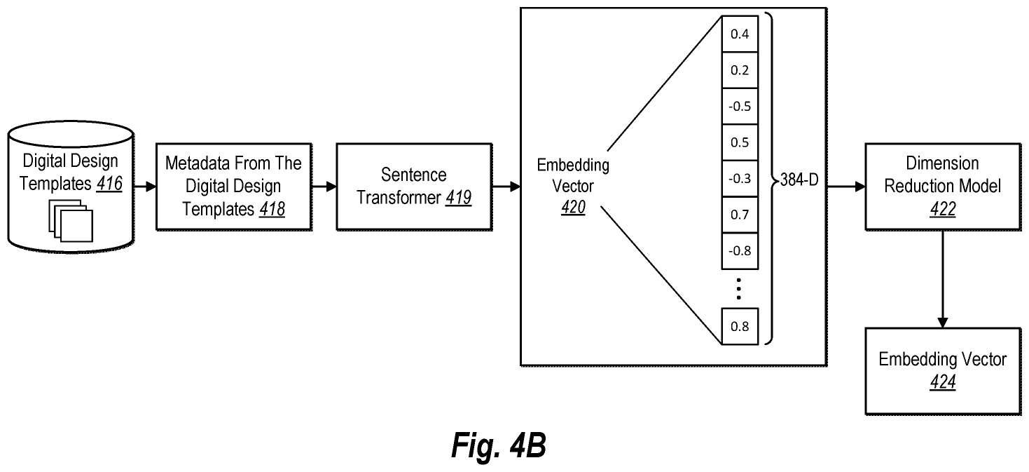

FIG. 4A provides additional details regarding the personalized digital design template recommendation system 102 extracting metadata from a digital design template in accordance with one or more embodiments. For example, FIG. 4A shows a digital design template with corresponding content metadata. In particular, the personalized digital design template recommendation system 102 utilizes the metadata shown in FIG. 4A to generate the template latent vectors (e.g., the embedding vectors) that represent the context of each digital design template stored within a dataset of digital design templates.

As shown in FIG. 4A, the personalized digital design template recommendation system 102 extracts metadata from the “Love and light to you this Diwali” digital design template. In particular, the metadata includes topics, tasks, categories, description, title, and text. For instance, the topics include astronomical, religious, festival, holiday, Diwali, religion, red, orange, celebration, white, stars, festival of light, and happy Diwali. Further, the tasks include greeting card, the description includes love and light to you this Diwali (e.g., the text written on the digital design template), the title includes Black & White Love and Light to You This Diwali A5 Greeting Card, and the text also includes love and light to you this Diwali.

For instance, the personalized digital design template recommendation system 102 extracts metadata from the digital design template for generalization of the digital design templates into a single latent space. Specifically, the generalization of the digital design templates into a single latent space based on the template content enables the personalized digital design template recommendation system 102 to contextually understand each digital design template. In doing so, the personalized digital design template recommendation system 102 associates individual user events that indicate interest for certain topics of digital design templates at any given time based on their recent and historical interactions (e.g., by determining semantic similarity).

FIG. 4B shows the personalized digital design template recommendation system 102 extracting metadata and generating an embedding vector in accordance with one or more embodiments. For example, as shown, the personalized digital design template recommendation system 102 extracts metadata 418 from digital design templates 416. In particular, the personalized digital design template recommendation system 102 extracts the metadata 418 from the digital design templates 416 utilizing a content search service search application programming interface (API). Specifically, the digital design templates 416 contain metadata fields alongside each digital design template. The personalized digital design template recommendation system 102 by utilizing the search API extracts the metadata 418 from all the digital design templates 416 within a dataset.

Moreover, the personalized digital design template recommendation system 102 for each template identifier also has associated metadata. For example, the personalized digital design template recommendation system 102 utilizes extracted metadata such as title, text, description, categories, topics, and tasks for a template identifier and collapses it into a single document per template identifier.

Furthermore, the personalized digital design template recommendation system 102 collapses the extracted metadata into a single document per template identifier. For example, the personalized digital design template recommendation system 102 concatenates the extracted terms into a single sentence/paragraph. The personalized digital design template recommendation system 102 utilizes a pre-trained Sentence Transformer to generate embedding vectors for digital design templates based on the extracted metadata. For instance, the personalized digital design template recommendation system 102 utilizes a pre-trained sentence transformer to encode each digital design template based on its extracted metadata with the focus on representing the content of the templates such as the topics or the title. In one or more implementations, the personalized digital design template recommendation system 102 utilizes the sentence transformer described by Lebanoff et al. in Learning to Fuse Sentences with Transformers for Summarization, In Proceedings of the 2020 Conference on Empirical Methods in Natural Language Processing (EMNLP), pages 4136-4142, the entire contents of which are hereby incorporated by reference. Alternatively, the personalized digital design template recommendation system 102 utilizes the sentence transformer described by by Jacob Devlin et al., BERT: Pre-training of Deep Bidirectional Transformers for Language Understanding, 2018, https://arxiv.org/abs/1810.04805, the entire contents of which are hereby incorporated by reference.

Additionally, of note, due to the versatility and simplicity of encoding in this manner, the personalized digital design template recommendation system 102 utilizes sentence transformer to learn other aspects of the template metadata such as styles, colors, or fonts. Furthermore, as new digital design templates are introduced, the personalized digital design template recommendation system 102 performs batch training jobs to automatically keep track of updating the latent space with newly added digital design templates and modifications to older templates with little to no supervision.

FIG. 4B shows the personalized digital design template recommendation system 102 generating embedding vectors 420 from metadata 418 of the digital design templates 416. In particular, the personalized digital design template recommendation system 102 extracts metadata 418 from the digital design templates 416. The personalized digital design template recommendation system 102 utilizes a sentence transformer 419 to generate the embedding vectors 420. In one or more implementations, the embedding vectors 420 include a 384-dimension embedding vector length. Moreover, as further shown, the personalized digital design template recommendation system 102 utilizes a dimension reduction model 422 to process the embedding vectors 420. For instance, the dimension reduction model 422 processes the embedding vectors 420 to generate an embedding vector 424 with an embedding vector length of two (e.g., 2-dimension embedding vector length).

FIG. 5A illustrates additional details regarding the dimension reduction model in accordance with one or more embodiments. For example, the personalized digital design template recommendation system 102 utilizes the dimension reduction model to reduce the dimensions of embedding vectors, which as mentioned above reduces a 384-dimension embedding vector to o a 2-dimension embedding vector or other reduced dimension (e.g., 3, 4, 10). In particular, the personalized digital design template recommendation system 102 utilizes a dimensionality reduction model, such as a uniform manifold approximation and projection (UMAP) model or a t-distribution stochastic neighbor embedding (t-SNE) model. In one or more implementations, the personalized digital design template recommendation system 102 utilizes a dimensionality reduction model described in U.S. Pat. No. 11,295,491, which is fully incorporated by reference herein.

As shown, FIG. 5A illustrates an example of a 2-dimensional UMAP projection of approximately 70,000 template embedding vectors. For example, each dot shown in FIG. 5A corresponds to a digital design template. Further, nearby points in the scatterplot shown in FIG. 5A corresponds to similar digital design templates. In particular, the personalized digital design template recommendation system 102 utilizes the UMAP for dimension reduction to reduce the storage footprint and for efficient inference to determine a nearest-neighbor of a specific point. Moreover, the personalized digital design template recommendation system 102 utilizes UMAP as shown in FIG. 5A for downstream applications such as for statistical visualization and data manipulation. To illustrate, the personalized digital design template recommendation system 102 implements the methods described in UMAP: Uniform Manifold Approximation and Projection for Dimension Reduction (https://arxiv.org/abs/1802.03426), which is incorporated herein by reference in its entirety.

FIGS. 5B-5C shows the personalized digital design template recommendation system 102 applying UMAP dimension reduction and selecting similar digital design templates. For example, as shown in FIG. 5B, the personalized digital design template recommendation system 102 randomly selects the digital design template on the left “Australia.” Based on the UMAP dimension reduction of the embedding vectors in FIG. 5A, the personalized digital design template recommendation system 102 identifies subsequent similar or neighboring digital design templates. In particular, FIG. 5B shows digital design templates for traveling in general and specifically for traveling in Japan, New Zealand, the United States, and Italy.

FIG. 5C also shows a random selection of a digital design template on the left “Happy Birthday Robin.” Further, based on the UMAP dimension reduction of the embedding vectors in FIG. 5A, the personalized digital design template recommendation system 102 also identifies subsequent similar or neighboring digital design templates. In particular, FIG. 5C shows various happy birthday digital design templates. For instance, FIGS. 5B and 5C illustrate that randomly selecting a digital design template and locating its nearest neighboring digital design template from the scatter plot shown in FIG. 5A results in identifying similarly structured digital design templates. The results shown in FIGS. 5B-5C suggest that two dimensions for the embedding vectors is sufficient for the personalized digital design template recommendation system 102 to identify similar digital design templates.

Moreover, in one or more embodiments, the personalized digital design template recommendation system 102 utilizes the UMAP implementation to generate a statistical visualization of the embedding vectors of the digital design templates. For example, the personalized digital design template recommendation system 102 generates the statistical visualization such as the one shown in FIG. 5A and provides it to a client device. In particular, by providing the statistical visualization of the digital design templates to the client device, this allows for a user of the client device to gain various insights. For instance, the user of the client device can hover over various points of the statistical visualization to see various similar digital design templates in reference to a specific point or for further use in downstream statistical analysis.

FIG. 6 shows the personalized digital design template recommendation system 102 monitoring an individual user event stream in accordance with one or more embodiments. For example, FIG. 6 shows the personalized digital design template recommendation system 102 monitoring a client device 600 to determine real-time individual user events. In particular, to generate recommendations in real time, the personalized digital design template recommendation system 102 tracks user behavior in real time. For instance, real-time includes anywhere from instantaneous tracking to a couple of seconds (e.g., a range of a millisecond to 10 seconds).

As shown in FIG. 6, the personalized digital design template recommendation system 102 monitors individual user events 603 in the individual user event stream 602. In particular, the individual user events 603 include template exports 604, search queries 606, template remixes 608, recent events 610, and individual geo-seasonal data 612. Specifically, the personalized digital design template recommendation system 102 focuses on the individual user events 603 of template exports, search keywords entered, and remixed templates (e.g., modified).

In one or more embodiments, the personalized digital design template recommendation system 102 treats the individual user events 603 of the template exports 604, search queries 606, and template remixes 608 in the listed order of importance (i.e., template exports as most important). For instance, the personalized digital design template recommendation system 102 rates the template exports 604 higher than the other individual user events because an export indicates a successful user interaction. Moreover, the personalized digital design template recommendation system 102 can further break down the template exports 604 into subsequent interactions. In particular, the personalized digital design template recommendation system 102 breaks down the template exports 604 into a user event of sharing the exported template on social media. For instance, the personalized digital design template recommendation system 102 ranks sharing the exported template on social media as the most important interaction.

Furthermore, the individual user event stream 602 includes a real time user event aggregation layer implemented using a database. For example, the personalized digital design template recommendation system 102 implements the real time user event aggregation layer in DynamoDB in Amazon Web Services (AWS). In particular, the personalized digital design template recommendation system 102 utilizing DynamoDB results in highly scalable and extremely efficient processing of large aggregation queries. Further, the personalized digital design template recommendation system 102 via DynamoDB receives event hooks for template exports 604, keyword searches entered (e.g., search queries 606), and template remixes 608 for each individual user which the event hooks are directly fed into AWS for aggregation against a user identifier (e.g., AdobeID or user_guid). Moreover, the personalized digital design template recommendation system 102 queries the aggregation layer using an individual user's identifier for which the aggregation layer provides within milliseconds all template identifiers, exports, remixes, and search terms associated with the user's interactions to the personalized digital design template recommendation system 102. To illustrate, the personalized digital design template recommendation system 102 implements DynamoDB as described in Fast NoSQL Key-Value Database-Amazon DynamoDB-Amazon Web Services, which is incorporated by reference herein in its entirety.

Thus, in one or more embodiments, the personalized digital design template recommendation system 102 aggregates individual user events 603 to create a combined user signal, generates a user embedding vector of the combined user signal utilizing the sentence transformer, and identifies a subset of digital design templates based on the user embedding vector. Furthermore, based on additional individual user events that occur subsequent to the individual user events 603, the personalized digital design template recommendation system 102 updates the identified digital design templates. For instance, the personalized digital design template recommendation system 102 detects additional individual user events, aggregates the additional user events with the individual user events 603 (e.g., to create another combined user signal) and generates a second user embedding vector. Accordingly, the personalized digital design template recommendation system 102 utilizes the second user embedding vector to identify a different subset of digital design templates.

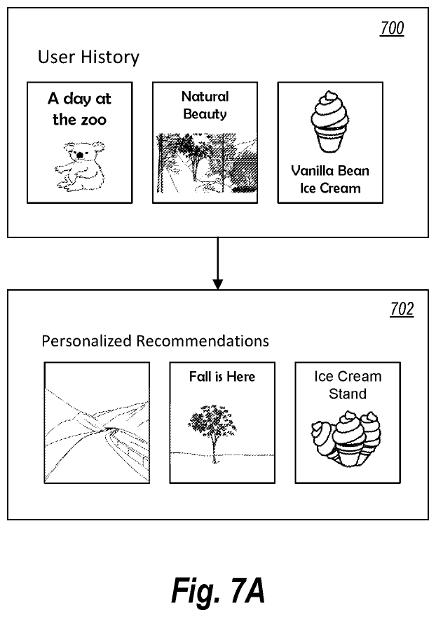

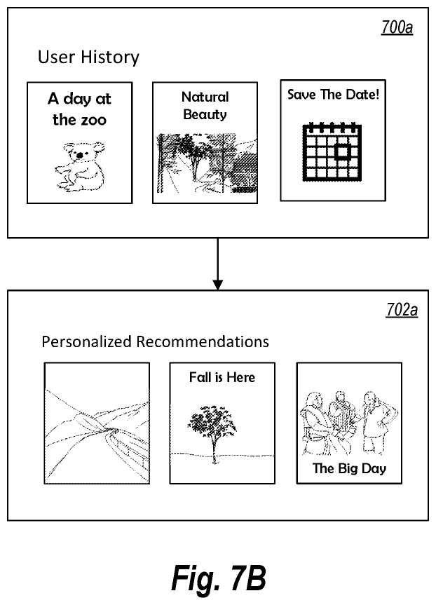

FIGS. 7A-7B shows the personalized digital design template recommendation system 102 utilizing user history (e.g., individual user events) to generate personalized recommendations in accordance with one or more embodiments. For example, FIG. 7A shows user history 700 which includes an individual user interaction with three types of templates. In particular, the individual user shows the user history 700 as including a zoo template, nature, and an ice cream template. Corresponding to the user history 700, FIG. 7A further shows personalized recommendations 702 as a traveling template, a nature template, and another template related to ice cream.

FIG. 7B shows a modification 700a to the user history 700. Rather than the same templates shown in FIG. 7A, FIG. 7B shows a “save the date” template instead of the ice cream template. In particular, in response to a change in the user history 700, the personalized digital design template recommendation system 102 provides personalized recommendations 702a. For instance, the personalized recommendations 702a differ from the personalized recommendations 702. Accordingly, the personalized digital design template recommendation system 102 also provides a new personalized recommendation that includes “the big day” template.

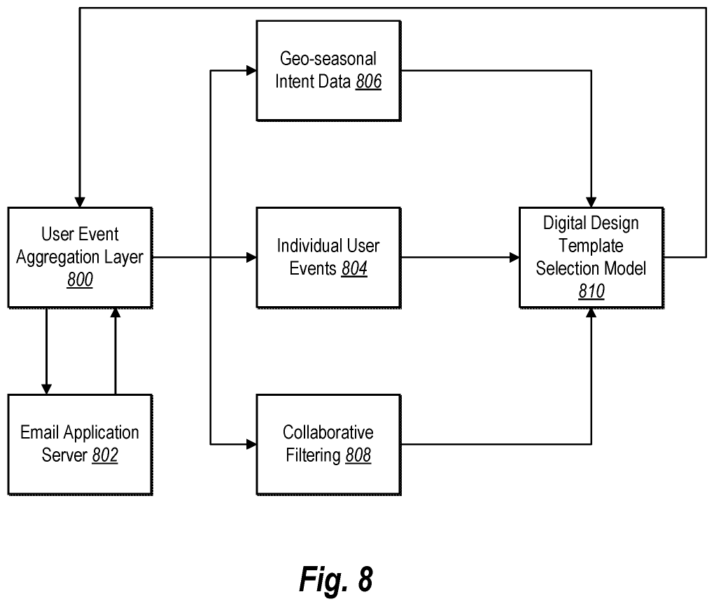

FIG. 8 shows an implementation of the personalized digital design template recommendation system 102 that supports an email application server in accordance with one or more embodiments. For example, FIG. 8 shows the personalized digital design template recommendation system 102 utilizing various models to support an email application server 802. In particular, the personalized digital design template recommendation system 102 utilizes a geo-seasonal intent data model 806, an individual user events model 804, and a collaborative filtering model 808.

For instance, the geo-seasonal intent data model 806 utilizes worldwide trends and activity to identify geo-seasonal intent trends for specific segments of users. In particular, the personalized digital design template recommendation system 102 implements the geo-seasonal intent data in the same manner described in U.S. patent application Ser. No. 17/938,253, filed on Oct. 5, 2022, and entitled, Generating Personalized Digital Design Template Recommendations, which is incorporated by reference herein in its entirety.

Further, the aforementioned individual user events model 804 incorporates the principles discussed above in FIG. 6 to personalize digital design template recommendations based on exports, search queries, or remixes. Moreover, the personalized digital design template recommendation system 102 utilizes the collaborative filtering model 808 to incorporate how other digital design users utilize various digital design templates. In particular, the personalized digital design template recommendation system 102 determines a similarity between digital design users and utilizes the similarity to surface various digital design template recommendations.

As further shown, FIG. 8 shows the personalized digital design template recommendation system 102 aggregating the geo-seasonal intent data model 806, the individual user events model 804, and the collaborative filtering model 808 into a digital design template selection model 810. Specifically, the digital design template selection model 810 allows the personalized digital design template recommendation system 102 to determine personalized recommendations for the email application server 802. For instance, FIG. 8 shows the email application server 802 in communication with the user event aggregation layer 800. As such, the email application server generates email template recommendations to a specific user by interfacing with the user event aggregation layer 800.

Although not shown in FIG. 8, in one or more embodiments, the personalized digital design template recommendation system 102 integrates multiple and various types of applications in a similar manner shown here. In doing so, the personalized digital design template recommendation system 102 reaches across multiple touchpoints/surfaces that users interact with over the web browsers, web applications, mobile applications, and other interfaces to provide personalized digital design template recommendations.

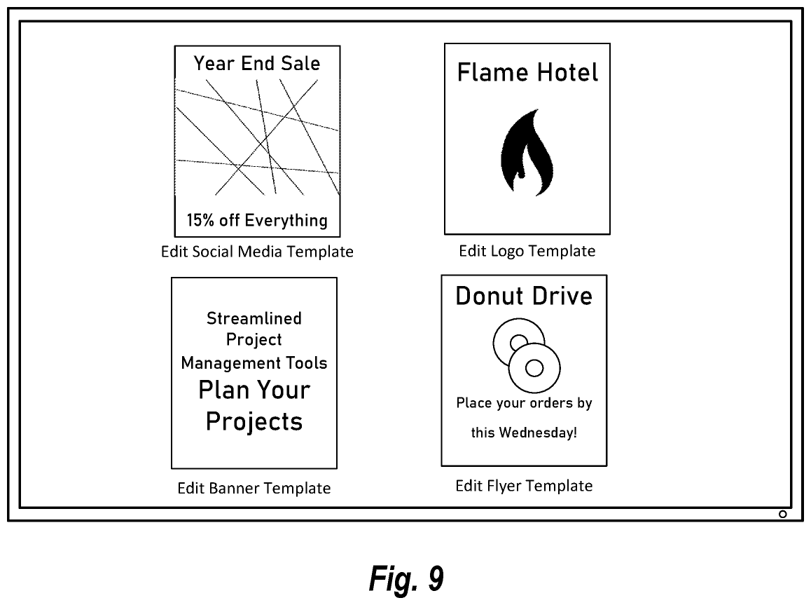

FIG. 9 shows an example graphical user interface generated to be sent by the email application server providing various recommendations. For example, FIG. 9 shows recommendations of the personalized digital design template recommendation system 102 send via the email application of the client device. The recommendations include a social media template, a logo template, a banner template, and a flyer template. The personalized digital design template recommendation system 102, in one or more implementations, integrates with Life Cycle Marketing (LCM) email campaigns. Thus, as shown in FIG. 9, the personalized digital design template recommendation system 102 provides email template recommendations utilizing the principles discussed above.

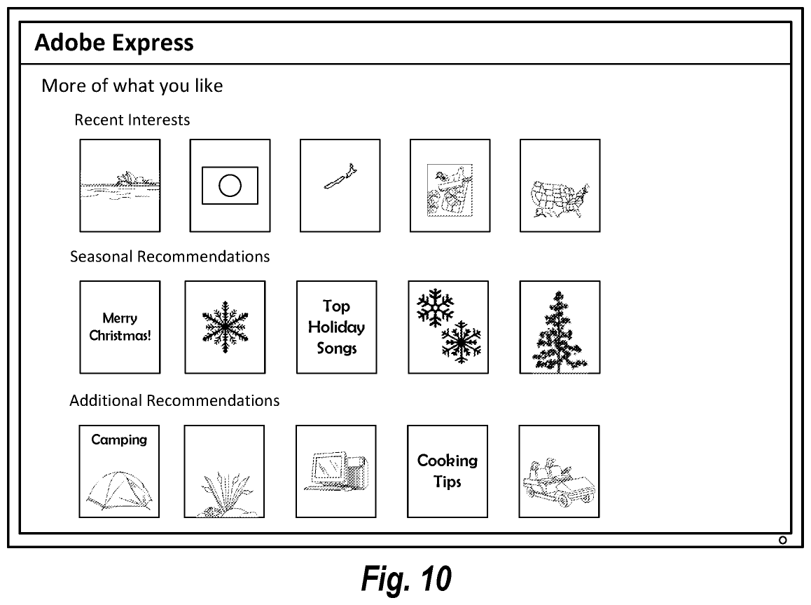

FIG. 10 shows an example graphical user interface of a digital design template platform providing digital design template recommendations. For example, FIG. 10 shows three recommendation rows. In particular, FIG. 10 shows a heading of “more of what you like” indicating a personalized recommendation. Furthermore, FIG. 10 also shows additional sub-headings such as “recent interests,” “seasonal recommendations,” and “additional recommendations.” For instance, the application utilized to display what is shown in FIG. 10 integrates the personalized digital design template recommendation system 102 utilizing the principles discussed above. Specifically, FIG. 10 shows various personalized recommendation rows and in one or more embodiments, the personalized digital design template recommendation system 102 updates the various recommendation rows in real time based on individual user events.

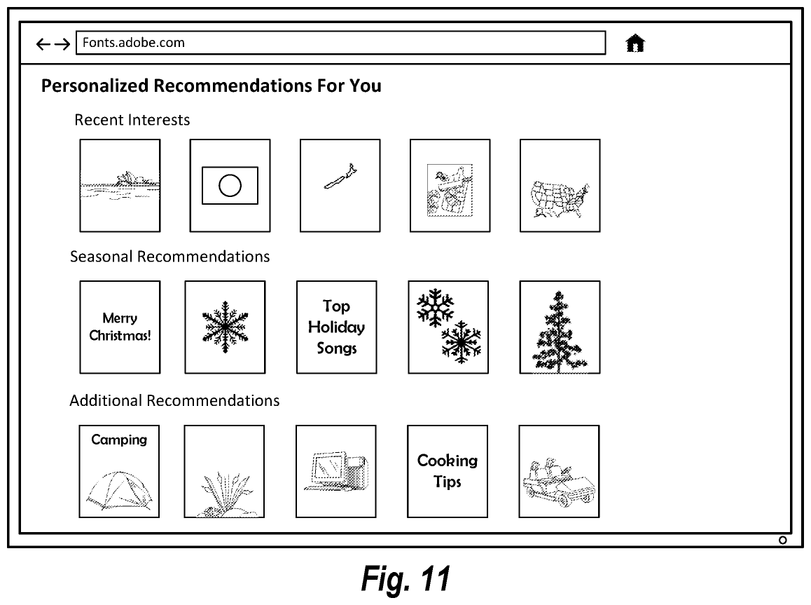

FIG. 11 shows an example graphical user interface of a web browser displaying personalized recommendations. For example, FIG. 11 shows the web browser displaying personalized recommendations such as “recent interests,” “seasonal recommendations,” and “additional recommendations.” In particular, the personalized digital design template recommendation system 102 collaborates with third party partner websites to promote routing of users to utilize the personalized digital design template recommendation system 102. For instance, a user on a different platform seeks to obtain a different type of font for a digital design project, in doing so, the user of the different platform is routed to fonts.adobe.com. Upon being routed to fonts.adobe.com, the personalized digital design template recommendation system 102 utilizes the principles discussed above to identify personalized digital design template recommendations for the user. Accordingly, the personalized digital design template recommendation system 102 receives user signals (e.g., individual user events) from third party sources, generates a user embedding vector, and further identifies a subset of digital design templates based on third party data.

Turning to FIG. 12, additional detail will now be provided regarding various components and capabilities of the personalized digital design template recommendation system 102. In particular, FIG. 12 illustrates an example schematic diagram of a computing device 1200 (e.g., the server(s) 106 and/or the client device 110) implementing the personalized digital design template recommendation system 102 in accordance with one or more embodiments of the present disclosure for components 1202-1210. As illustrated in FIG. 12, the personalized digital design template recommendation system 102 includes a metadata extractor 1202, a transformer 1204 which includes a subcomponent of an embedding vectors generator 1206 and a user embedding vectors generator 1208, a template recommendation generator 1210, and data storage 1212.

The metadata extractor 1202 processes digital design templates from a database. For example, the metadata extractor 1202 extracts metadata from a plurality of digital design template included within a digital design template database. In doing so, the metadata extractor 1202 compiles per template identifier, a document that includes the extracted metadata. Furthermore, the metadata extractor 1202 passes the extracted metadata to the transformer 1204.

The transformer 1204 processes the extracted metadata. For example, the transformer 1204 generates embedding vectors from the extracted metadata for the plurality of digital design templates. Further, the transformer 1204 passes the generated embedding vectors to various models such as the exponential decay function and the single latent embedding space for further downstream tasks. Moreover, the embedding vectors generator 1206 assists the transformer 1204 in generating the embedding vectors. Specifically, the embedding vectors generator 1206 manages the generation of embedding vectors for the plurality of digital design templates.

Furthermore, as shown, the transformer 1204 also includes a user embedding vectors generator 1208. For example, the user embedding vectors generator 1208 processes individual user events (e.g., exports, remixes, and/or search queries). In particular, based on processing the individual user events, the embedding vectors generator 1208 generates a user embedding vector that represents an aggregate of the individual user events. Further, the user embedding vectors generator 1208 receives updates of the individual user events (e.g., receives updates every few seconds regarding new individual user events) and generates an additional user embedding vector that represents an updated aggregate of the individual user events.

The template recommendation generator 1210 generates digital design template recommendations by identifying a subset of digital design templates. For example, the template recommendation generator 1210 receives the assigned weights and analyzes the various embedding vectors to identify similar digital design templates. In particular, the template recommendation generator 1210 utilizes a similarity search model to identify the subset of digital design templates. For instance, the template recommendation generator 1210 identifies digital design templates that satisfy a similarity threshold of the embedding vectors from the individual user events. Moreover, the template recommendation generator 1210 provides the generated recommendation(s) to a client device.

As shown in FIG. 12, the personalized digital design template recommendation system 102 also includes data storage 1212. In particular, data storage 1212 (implemented by one or more memory devices) can include digital design templates, embedding vectors for the digital design templates, individual user events, embedding vectors for the individual user events, and recommendations.

Each of the components 1202-1212 of the personalized digital design template recommendation system 102 can include software, hardware, or both. For example, the components 1202-1212 can include one or more instructions stored on a computer-readable storage medium and executable by processors of one or more computing devices, such as a client device or server device. When executed by the one or more processors, the computer-executable instructions of the personalized digital design template recommendation system 102 can cause the computing device(s) to perform the methods described herein. Alternatively, the components 1202-1212 can include hardware, such as a special-purpose processing device to perform a certain function or group of functions. Alternatively, the components 1202-1212 of the personalized digital design template recommendation system 102 can include a combination of computer-executable instructions and hardware.

Furthermore, the components 1202-1212 of the personalized digital design template recommendation system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1202-1212 of the personalized digital design template recommendation system 102 may be implemented as a stand-alone application, such as a desktop or mobile application. Furthermore, the components 1202-1212 of the personalized digital design template recommendation system 102 may be implemented as one or more web-based applications hosted on a remote server. Alternatively, or additionally, the components 1202-1212 of the personalized digital design template recommendation system 102 may be implemented in a suite of mobile device applications or “apps.” For example, in one or more embodiments, the personalized digital design template recommendation system 102 can comprise or operate in connection with digital software applications such as ADOBE® CREATIVE CLOUD EXPRESS, ADOBE® PHOTOSHOP, ADOBE® ILLUSTRATOR, ADOBE® PREMIERE, ADOBE® INDESIGN, and/or ADOBE® EXPERIENCE CLOUD. “ADOBE,” “PHOTOSHOP,” “INDESIGN,” and “ILLUSTRATOR”. The foregoing are either registered trademarks or trademarks of Adobe Inc. in the United States and/or other countries.

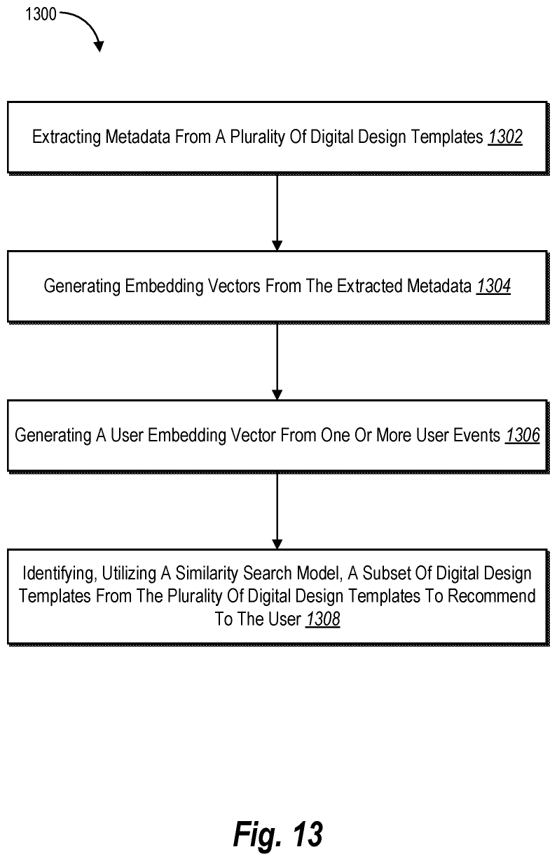

FIGS. 1-12, the corresponding text, and the examples provide a number of different methods, systems, devices, and non-transitory computer-readable media of the personalized digital design template recommendation system 102. In addition to the foregoing, one or more embodiments can also be described in terms of flowcharts comprising acts for accomplishing the particular result, as shown in FIG. 13. FIG. 13 may be performed with more or fewer acts. Further, the acts may be performed in different orders. Additionally, the acts described herein may be repeated or performed in parallel with one another or in parallel with different instances of the same or similar acts.

FIG. 13 illustrates a flowchart of a series of acts 1300 for identifying a subset of digital design templates utilizing embedding vectors in accordance with one or more embodiments. FIG. 13 illustrates acts according to one embodiment, alternative embodiments may omit, add to, reorder, and/or modify any of the acts shown in FIG. 13. In some implementations, the acts of FIG. 13 are performed as part of a method. For example, in some embodiments, the acts of FIG. 13 are performed as part of a computer-implemented method. Alternatively, a non-transitory computer-readable medium can store instructions thereon that, when executed by at least one processor, cause a computing device to perform the acts of FIG. 13. In some embodiments, a system performs the acts of FIG. 13. The system further includes at least one server device configured to cause the system to perform the acts of FIG. 13.

The series of acts 1300 includes an act 1302 of extracting metadata from a plurality of digital design templates, an act 1304 of generating embedding vectors from the extracted metadata, an act 1306 of generating a user embedding vector from one or more user events, and an act 1308 of identifying, utilizing a similarity search model, a subset of digital design templates to recommend to the user.

In particular, the act 1302 includes extracting metadata from digital design templates from a database of digital design templates. The act 1304 includes generating, utilizing a transformer, a plurality embedding vectors for the digital design templates from the extracted metadata. The act 1306 includes generating, utilizing the transformer, a user embedding vector from one or more user events of a user, the individual user events. The act 1308 includes identifying, utilizing a similarity search model, a subset of digital design templates from the digital design templates to recommend to the user by identifying one or more embedding vectors of the plurality of embedding vectors that satisfy a similarity threshold to the user embedding vector.

In one or more embodiments, the series of acts 1300 also includes extracting at least one of title of digital design templates, text, description, categories, topics, or tasks. Further, in one or more embodiments the series of acts 1300 also includes utilizing a sentence transformer to generate the plurality of embedding vectors that represent content within the digital design templates. Moreover, in one or more embodiments, the series of acts 1300 includes detecting one or more events of the user in real-time by utilizing a user event stream aggregation model. The one or more events include digital design template remixes, digital design template exports, and search queries performed by the user, and generating the user embedding vector from the detected one or more events. Additionally, in one or more embodiments, the series of acts 1300 includes generating a weight for each of the one or more user events of the user by utilizing an exponential decay function.

In one or more embodiments, the series of acts 1300 includes generating the weight for each of the one or more user events based on at least one of recency of the one or more user events or individualized geo-seasonal intent. Generating the weight based on individualized geo-seasonal intent comprises determining an individualized annual pattern of behavior and identifying a number of digital design templates of the subset of digital design templates based on the weight for each of the one or more user events. Further, in one or more embodiments the series of acts 1300 also includes comparing, utilizing the similarity search model, the user embedding vector with the plurality of embedding vectors for the digital design templates within a single latent space to determine which embedding vectors of the of the one or more embedding vectors satisfy the similarity threshold to the user embedding vector. Moreover, in one or more embodiments, the series of acts 1300 includes performing real-time pairwise distance computations across the single latent space to identify, in real-time, the subset of digital design templates.

In one or more embodiments, the series of acts 1300 also includes generating, utilizing a transformer, the plurality of embedding vectors of the digital design templates by extracting metadata from the digital design templates. The series of acts 1300 also includes detecting, utilizing a real-time user event aggregation model, one or more user events of a user with respect to the database of digital design templates. Further, the series of acts 1300 includes assigning, utilizing an exponential decay function, weights to the one or more user events to generate one or more weighted user events. The series of acts 1300 includes generating, utilizing the transformer, a user embedding vector from the one or more weighted user events. Additionally, the series of acts 1300 includes identifying, utilizing a similarity search model, a subset of digital design templates from the database of digital design templates to recommend to the user by identifying one or more embedding vectors of the plurality of embedding vectors that satisfy a similarity threshold to the user embedding vector.

Further, in one or more embodiments the series of acts 1300 also includes extracting stylistic elements of the digital design templates based on at least one of title of digital design templates, text, description, categories, topics, or tasks. Moreover, in one or more embodiments, the series of acts 1300 includes aggregating, utilizing the real-time user event aggregation model, the one or more user events into a combined user signal, and generating, utilizing the transformer, the user embedding vector from the combined user signal. Additionally, in one or more embodiments, the series of acts 1300 includes detecting that the one or more user events include a digital design template export and a search query performed by the user.

Further, in one or more embodiments the series of acts 1300 includes assigning, utilizing the exponential decay function, a first weight to the digital design template export and a second weight to the search query performed by the user, wherein the first weight is greater than the second weight. Moreover, in one or more embodiments, the series of acts 1300 includes identifying a number of digital design templates of the subset of digital design templates based on the weights for each of the one or more user events. Additionally, in one or more embodiments, the series of acts 1300 includes comparing, utilizing the similarity search model, the user embedding vector with the plurality of embedding vectors for the digital design templates within a single latent space to determine pairwise distance computations. The series of acts 1300 includes determining which embedding vectors of the one or more embedding vectors satisfy the similarity threshold to the user embedding vector based on the pairwise distance computations.

Further, in one or more embodiments the series of acts 1300 includes extracting from the digital design templates at least one of title, text, description, categories, topics, or tasks and determining stylistic elements of the digital design templates based on at least one of the title, the text, the description, the categories, the topics, or the tasks. Moreover, in one or more embodiments, the series of acts 1300 includes detecting one or more events of the user in real-time by utilizing a user event stream aggregation model. In one or more implementations, the one or more events include digital design template remixes, digital design template exports, and search queries performed by the user. Additionally, in one or more embodiments, the series of acts 1300 includes generating a weight for each of the one or more user events of the user by utilizing an exponential decay function and identifying a number of digital design templates of the subset of digital design templates based on the weight for each of the one or more user events. Further, in one or more embodiments the series of acts 1300 includes utilizing the similarity search model, the user embedding vector with the plurality of embedding vectors for the digital design templates to determine in real-time which embedding vectors of the one or more embedding vectors satisfy the similarity threshold to the user embedding vector.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 14 illustrates a block diagram of an example computing device 1400 that may be configured to perform one or more of the processes described above. One will appreciate that one or more computing devices, such as the computing device 1400 may represent the computing devices described above (e.g., the server(s) 106 and/or the client device 110). In one or more embodiments, the computing device 1400 may be a mobile device (e.g., a mobile telephone, a smartphone, a PDA, a tablet, a laptop, a camera, a tracker, a watch, a wearable device). In some embodiments, the computing device 1400 may be a non-mobile device (e.g., a desktop computer or another type of client device). Further, the computing device 1400 may be a server device that includes cloud-based processing and storage capabilities.

As shown in FIG. 14, the computing device 1400 can include one or more processor(s) 1402, memory 1404, a storage device 1406, input/output interfaces 1408 (or “I/O interfaces 1408”), and a communication interface 1410, which may be communicatively coupled by way of a communication infrastructure (e.g., bus 1412). While the computing device 1400 is shown in FIG. 14, the components illustrated in FIG. 14 are not intended to be limiting. Additional or alternative components may be used in other embodiments. Furthermore, in certain embodiments, the computing device 1400 includes fewer components than those shown in FIG. 14. Components of the computing device 1400 shown in FIG. 14 will now be described in additional detail.

In particular embodiments, the processor(s) 1402 includes hardware for executing instructions, such as those making up a computer program. As an example, and not by way of limitation, to execute instructions, the processor(s) 1402 may retrieve (or fetch) the instructions from an internal register, an internal cache, memory 1404, or a storage device 1406 and decode and execute them.

The computing device 1400 includes memory 1404, which is coupled to the processor(s) 1402. The memory 1404 may be used for storing data, metadata, and programs for execution by the processor(s). The memory 1404 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1404 may be internal or distributed memory.

The computing device 1400 includes a storage device 1406 including storage for storing data or instructions. As an example, and not by way of limitation, the storage device 1406 can include a non-transitory storage medium described above. The storage device 1406 may include a hard disk drive (HDD), flash memory, a Universal Serial Bus (USB) drive or a combination these or other storage devices.

As shown, the computing device 1400 includes one or more I/O interfaces 1408, which are provided to allow a user to provide input to (such as user strokes), receive output from, and otherwise transfer data to and from the computing device 1400. These I/O interfaces 1408 may include a mouse, keypad or a keyboard, a touch screen, camera, optical scanner, network interface, modem, other known I/O devices or a combination of such I/O interfaces 1408. The touch screen may be activated with a stylus or a finger.

The I/O interfaces 1408 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1408 are configured to provide graphical data to a display for presentation to a user. The graphical data may be representative of one or more graphical user interfaces and/or any other graphical content as may serve a particular implementation.

The computing device 1400 can further include a communication interface 1410. The communication interface 1410 can include hardware, software, or both. The communication interface 1410 provides one or more interfaces for communication (such as, for example, packet-based communication) between the computing device and one or more other computing devices or one or more networks. As an example, and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI. The computing device 1400 can further include a bus 1412. The bus 1412 can include hardware, software, or both that connects components of computing device 1400 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
extracting metadata from digital design templates;
generating, utilizing a transformer, a plurality of embedding vectors for the digital design templates from the extracted metadata;
generating, utilizing the transformer, a user embedding vector from one or more user events of a user; and
identifying, utilizing a similarity search model, a subset of digital design templates from the digital design templates to recommend to the user by identifying one or more embedding vectors of the plurality of embedding vectors that satisfy a similarity threshold to the user embedding vector.

2. The method of claim 1, wherein extracting the metadata from the digital design templates comprises extracting at least one of title of digital design templates, text, description, categories, topics, or tasks.

3. The method of claim 1, wherein generating the plurality of embedding vectors further comprises:
utilizing a sentence transformer to generate the plurality of embedding vectors that represent content within the digital design templates; and
storing the plurality of embedding vectors in a database corresponding with the digital design templates.

4. The method of claim 1, further comprising:
detecting one or more events of the user in real-time by utilizing a user event stream aggregation model, wherein the one or more events include digital design template remixes, digital design template exports, and search queries performed by the user; and
generating the user embedding vector from the detected one or more events.

5. The method of claim 1, further comprising generating a weight for each of the one or more user events of the user by utilizing an exponential decay function.

6. The method of claim 5, further comprising:
generating the weight for each of the one or more user events based on at least one of recency of the one or more user events or individualized geo-seasonal intent, wherein generating the weight based on individualized geo-seasonal intent comprises determining an individualized annual pattern of behavior; and
identifying a number of digital design templates of the subset of digital design templates based on the weight for each of the one or more user events.

7. The method of claim 1, wherein identifying the subset of digital design templates further comprises comparing, utilizing the similarity search model, the user embedding vector with the one or more embedding vectors for the digital design templates within a single latent space to determine which embedding vectors of the one or more embedding vectors satisfy the similarity threshold to the user embedding vector.

8. The method of claim 7, wherein comparing the user embedding vector with the one or more embedding vectors for the digital design templates further comprises performing real-time pairwise distance computations across the single latent space to identify, in real-time, the subset of digital design templates.

9. A system comprising:
one or more memory components; and
one or more processing devices coupled to the one or more memory components, the one or more processing devices to perform operations comprising:
generating, utilizing a transformer, a plurality of embedding vectors for digital design templates by extracting metadata from the digital design templates;
detecting, utilizing a real-time user event aggregation model, one or more user events of a user with respect to the digital design templates;
assigning, utilizing an exponential decay function, weights to the one or more user events to generate one or more weighted user events;
generating, utilizing the transformer, a user embedding vector from the one or more weighted user events; and
identifying, utilizing a similarity search model, a subset of digital design templates from the digital design templates to recommend to the user by identifying one or more embedding vectors of the plurality of embedding vectors that satisfy a similarity threshold to the user embedding vector.

10. The system of claim 9, wherein extracting the metadata from the digital design templates further comprises extracting stylistic elements of the digital design templates based on at least one of title of digital design templates, text, description, categories, topics, or tasks.

11. The system of claim 9, wherein the operations further comprise:
aggregating, utilizing the real-time user event aggregation model, the one or more user events into a combined user signal; and
generating, utilizing the transformer, the user embedding vector from the combined user signal.

12. The system of claim 9, wherein detecting one or more user events of a user further comprises detecting that the one or more user events include a digital design template export and a search query performed by the user.

13. The system of claim 12, wherein assigning the weights further comprises assigning, utilizing the exponential decay function, a first weight to the digital design template export and a second weight to the search query performed by the user, wherein the first weight is greater than the second weight.

14. The system of claim 9, wherein assigning the weights to the one or more user events further comprises identifying a number of digital design templates of the subset of digital design templates based on the weights for each of the one or more user events.

15. The system of claim 9, wherein identifying the subset of digital design templates further comprises:
comparing, utilizing the similarity search model, the user embedding vector with the one or more embedding vectors for the digital design templates within a single latent space to determine pairwise distance computations; and
determining which embedding vectors of the one or more embedding vectors satisfy the similarity threshold to the user embedding vector based on the pairwise distance computations.

16. A non-transitory computer-readable medium storing executable instructions which, when executed by at least one processing device, cause the at least one processing device to perform operations comprising:
extracting metadata from digital design templates from a database of digital design templates;
generating, utilizing a transformer, a plurality of embedding vectors for the digital design templates from the extracted metadata;
generating, utilizing the transformer, a user embedding vector from one or more user events of a user; and
identifying, utilizing a similarity search model, a subset of digital design templates from the database of digital design templates to recommend to the user by identifying one or more embedding vectors of the plurality of embedding vectors that satisfy a similarity threshold to the user embedding vector.

17. The non-transitory computer-readable medium of claim 16, wherein extracting the metadata further comprises:
extracting from the digital design templates at least one of title, text, description, categories, topics, or tasks; and
determining stylistic elements of the digital design templates based on at least one of the title, the text, the description, the categories, the topics, or the tasks.

18. The non-transitory computer-readable medium of claim 16, wherein the operations further comprise detecting one or more events of the user in real-time by utilizing a user event stream aggregation model, wherein the one or more events include digital design template remixes, digital design template exports, and search queries performed by the user.

19. The non-transitory computer-readable medium of claim 16, wherein the operations further comprise:
generating a weight for each of the one or more user events of the user by utilizing an exponential decay function; and
identifying a number of digital design templates of the subset of digital design templates based on the weight for each of the one or more user events.

20. The non-transitory computer-readable medium of claim 16, wherein identifying the subset of digital design templates further comprises comparing, utilizing the similarity search model, the user embedding vector with the one or more embedding vectors for the digital design templates to determine in real-time which embedding vectors of the one or more embedding vectors satisfy the similarity threshold to the user embedding vector.
